(19) United States
(12) Patent Application Publication
(10) Pub. No.: US 2013/0000461 A1
(43) Pub. Date: Jan. 3, 2013

(54) METHOD AND APPARATUS FOR MUSICAL INSTRUCTION

(76) Inventor: Justine G. Shaw, Trumbull, CT (US)

(21) Appl. No.: 13/491,118

(22) Filed: Jun. 7, 2012

Related U.S. Application Data
(60) Provisional application No. 61/494,622, filed on Jun. 8, 2011.

(51) Int. Cl. G09B 15/04

(52) U.S. Cl. 84/477 R

(57) ABSTRACT

An apparatus that includes an outer casing, having a first cover (front cover) and a second cover (back cover). The first cover and second cover having a contour shape of a selected musical instrument. The contour may be for example, the shape of a guitar, piano, drum set or other musical instrument. A plurality of pages are bound between the front cover and the back cover. The pages having the contour shape of the first cover and the second cover. A musical chip module for outputs audible musical signals corresponding to the contour shape when pressed, or the page is opened, or the module is otherwise actuated, such as motion or voice.

### CROSS-REFERENCE TO RELATED APPLICATIONS

This application claims priority to U.S. Provisional Application No. 61/494,622 filed Jun. 8, 2011. The entirety of which is hereby incorporated by reference herein.

### BACKGROUND

1. Field of the Invention

This invention relates generally to a system and method of providing musical instruction and particularly musical instruction to young children. More specifically, the present invention relates to musical instruction using a series of representative icons associated with a particular musical note for a particular musical instrument.

2. Background Discussion

Musical instruction is seen to be most effective when introduced to students at a young age. There are many conventional methods used to introduce children to musical instruments. However, the present invention provides an enhanced learning technique that provides effective musical instruction to students even before they have developed articulated speech.

### SUMMARY

Embodiments of the present invention are directed to an apparatus that includes an outer casing, having a first cover (front cover) and a second cover (back cover). The first cover and second cover having a contour shape of a selected musical instrument. The contour may be for example, the shape of a guitar, piano, drum set or other musical instrument. A plurality of pages are bound between the front cover and the back cover. The pages having the contour shape of the first cover and the second cover. A musical chip module for outputs audible musical signals corresponding to the contour shape when pressed, or the page is opened, or the module is otherwise actuated, such as motion or voice.

Yet another embodiment of the present invention is directed to the apparatus described above, wherein the contour shape is of a musical instrument.

Yet another embodiment of the present invention is directed to the apparatus described above, wherein the audible musical signals include notes.

Yet another embodiment of the present invention is directed to the apparatus described above, wherein the audible musical signals include songs.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIGS. 1A-1D show various views of instructional books according to embodiments of the present invention.

FIGS. 2A-2B show a perspective view of instructional books according to an embodiment of the present invention.

FIGS. 3A-3B show a front and open view of an instructional book according to an embodiment of the present invention.

FIG. 4 shows a perspective view of a guitar instructional book.

FIG. 5 shows an example of a piano instructional book.

FIG. 6 shows an example of a drum instructional book.

FIG. 7 shows an example of a portion of a guitar book.

FIG. 8 shows a perspective view of a guitar book.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices. The processing modules may be for example, microchips mounted on a suitable location on the particular book. The module may store musical audio data that is accessed by the user.

One embodiment of the present invention is directed to teaching young students, such as students under one year of age, musical notes and musical instrument instruction using an instructional method that is similar to language assimilation. As students hear musical notes, the students should start to relate them to an associated instrument. When the assimilation occurs at an early age, instruction is easier and more readily comprehended.

Another embodiment of the present invention is directed to using particular music genres and instruments used with the genre. For example, one genre may be rock and roll music and utilizing instruments such as guitar, bass, drums and piano. Another genre is classical, utilizing instruments such as the violin, cello, viola, etc. Yet another genre is impressionistic, utilizing instruments such as the trumpet, trombone, etc.

According to the present invention, a series, or plurality of books may be used. For example, a series of three books may form a book collection for each instrument.

The first book may be, for example, an introduction to the sound of each major music note for the instrument. Each page may be a bright color to catch the user's eye. The letter of the note may be on the page along with a button shaped as a music note. When a user presses the music note the user will hear the sound of the note in which ever instrument book is being used. For example, if a guitar book is used, the user will hear “A” major from the guitar string.

Another embodiment of the present invention is utilizing a drum book. The drums book may be a little different than the guitar book described above. Instead of hearing notes, as in the guitar book, when using the drum book, the user will hear different drums. The buttons on the drum book, instead of being shaped as a note (as in the guitar book) will be shaped as a drum stick and each page can feature the look of the drum. For example, the user will see and hear what the sound of a snare drum would make.

By using the books according to the present invention, the user, typically a baby will start to hear what the actual note sounds like for the instrument of interest.

According to another embodiment, a second book may also be used. The second book can be used for the introduction to each major note scale. Each instrument will have its own book and each book is shaped as the associated instrument. The pages of the second book will consist of each major music note scale. The pages of the book will also have a button in place where the note is and when the button is pressed, the user will hear the actual note. For example, the guitar book will have the shape of the guitar with the pages being the neck. The first page will be “A” major scale with the buttons placed properly to hear the correct note. The drums book will again be a little different. Like the others, the drums book will be shaped as a drum set but instead of the scale the notes will be counting notes. For example, each page will have a button to press and the user hear the count. The pages will indicate, to the user, what county you are hearing.

Thus, the purpose of the second book is to introduce the user to the placement and sound of warm up exercises to the individual instrument.

The third book is similar to the second book since the third book is also in shape of the instrument. Each page of the third book would be a different note. As the user turns each page and press the buttons the user is creating a song. The final page of the third book may have a button that when the user presses the button plays back the song. For example, the song that is played back could be a song from a well known rock musician and a song that is basic for the instrument. Alternatively, the song could be a song created by the user or other song.

Thus, one purpose of the third book is to introduce assimilation or combining different notes to make a song as well as different instruments.

Each instrument has correct placement and actual sound of all the major notes so the user can become accustomed to an actual instrument. For example, the instruments may be depicted in bright and/or bold colors to catch the user's eye. The books may also have mirrors on them and a bubble blower attached so when the user hits a certain note it will blow bubbles. These extra features are used to maintain excitement and attention and to keep the user's mind stimulated.

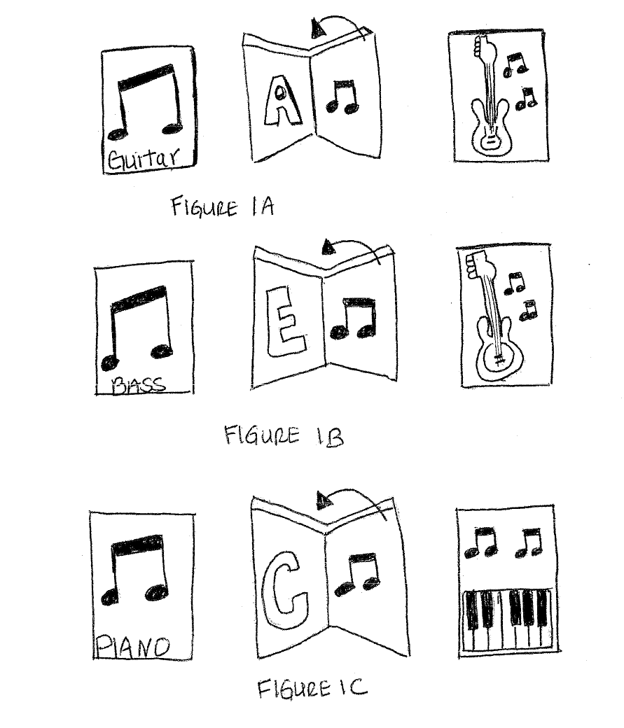

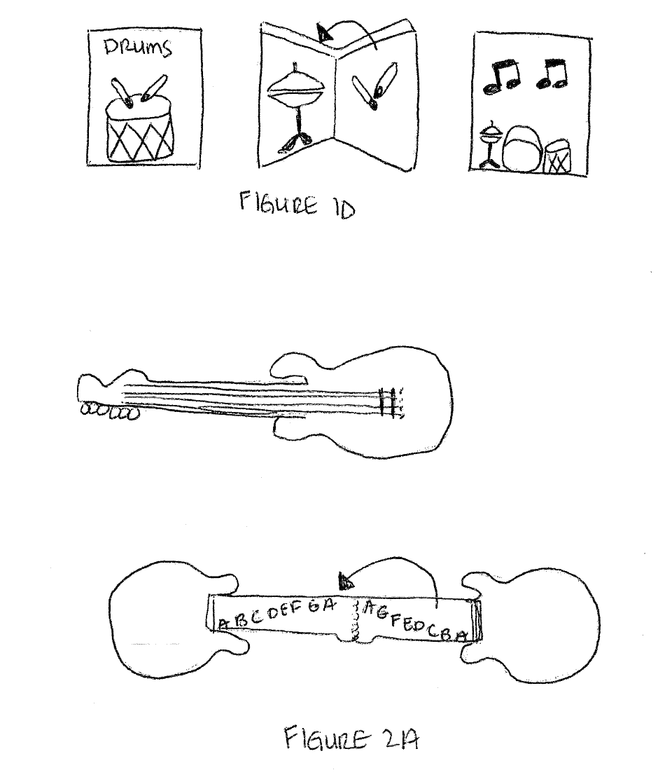

FIGS. 1A-1D show various views of instructional books according to embodiments of the present invention. Specifically, FIG. 1A shows a front view of a guitar book, an open view and a back view. The open view shows a note “A” on one page and depiction of a corresponding note on the facing page. The back view shows a perspective view of the instrument (i.e., guitar). The back portion also includes a button, that when pressed, outputs an audible signal of the instrument shown. Similarly, FIGS. 1B, 1C and 1D show a front view of a book, an open view and a back view of a bass, piano and drums, respectively.

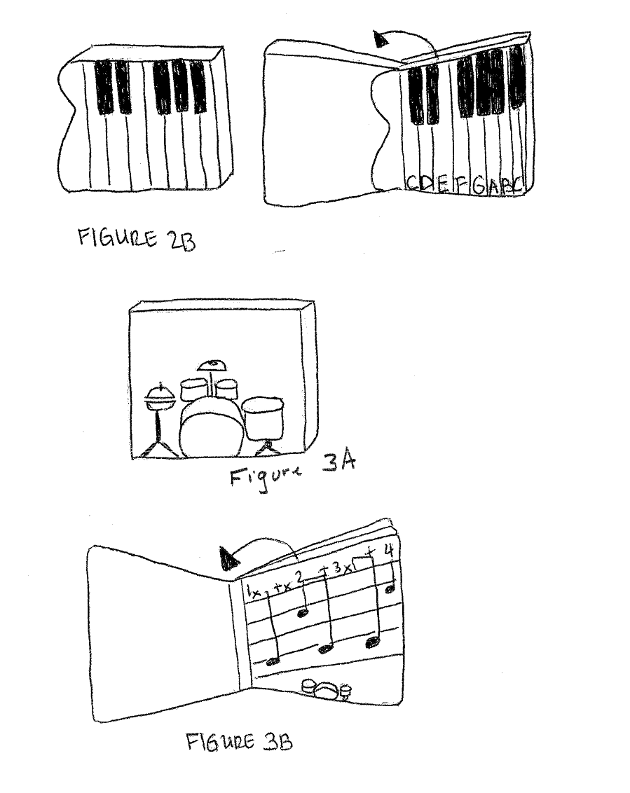

FIGS. 2A-2B show a perspective view of instructional books according to an embodiment of the present invention. Specifically, FIG. 2A shows a closed and open guitar book. The shape of the book is a guitar that opens at the fret end to display notes. Similar to FIG. 2A, FIG. 2B shows a front and open view of a piano instructional book according to an embodiment of the present invention. In this embodiment, the outside shape is that of a piano keyboard

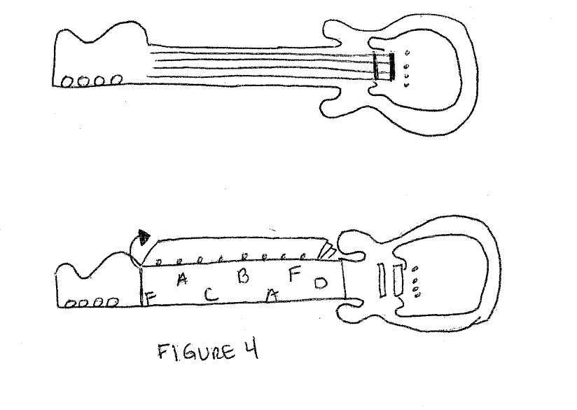

FIGS. 3A-3B show a front and open view of a drum instructional book according to an embodiment of the present invention. In this embodiment, the outside shape displays a drum set (FIG. 3A) and the open book (FIG. 3B) shows musical instruments for the drum.

FIG. 4 shows a perspective view of a guitar instructional book. As shown in FIG. 4, the various notes are displayed on the fret portion. When pressed, the corresponding musical note will be output from the book.

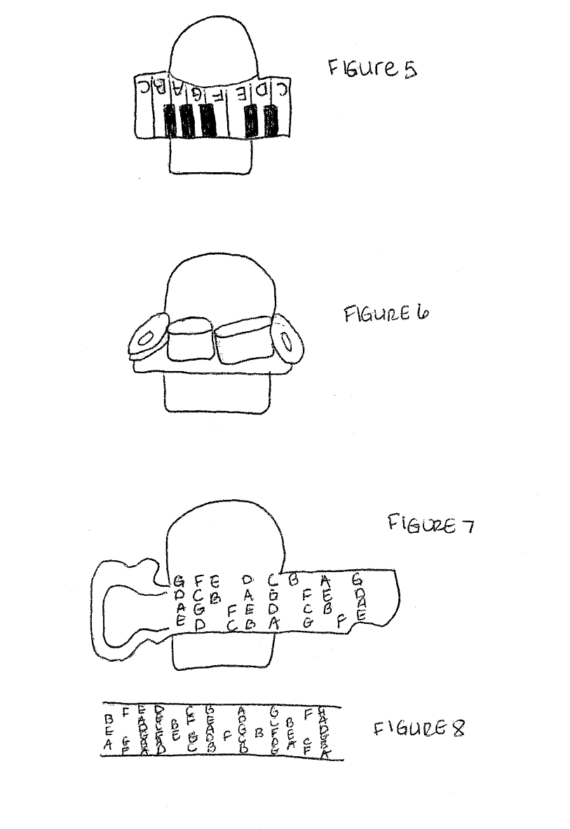

FIGS. 5-8 show a perspective view of various books (piano keyboard, drum set and guitar, respectively). The instructional books have a handle for the user to hold.

The musical notes provided, or activated, or played, may be implemented with an audio chip in the book. This is typically mounted or disposed in a cover portion, or other non-obtrusive location. The chips may be for example, a CMOS LSI IC, or an AVR microcontroller, such as the AVR 335.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein.

What is claimed is:

1. An apparatus comprising:
an outer casing, having a first cover and a second cover, the first cover and second cover having a contour shape of a selected musical instrument;
a plurality of pages bound into the outer casing between the first cover and the second cover, the plurality of pages each having the contour shape of the first cover and the second cover;
a musical chip module for outputting audible musical signals corresponding to the contour shape.

2. The apparatus as claimed in claim 1, wherein the contour shape is of a musical instrument.

3. The apparatus as claimed in claim 1, wherein the audible musical signals include notes.

4. The apparatus as claimed in claim 1, wherein the audible musical signals include songs.
